(19) United States
(12) Patent Application Publication
(10) Pub. No.: US 2010/0065707 A1
(43) Pub. Date: Mar. 18, 2010

(54) DEVICE FOR SECURING A CAMERA TO A CARRIER

(76) Inventor: Mathias Hansel, Rummingen (DE)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/375,777

(22) PCT Filed: Jul. 7, 2007
(86) PCT No.: PCT/EP2007/006041

§ 371 Date: Oct. 6, 2009

(30) Foreign Application Priority Data
Aug. 2, 2006 (DE) 10 2006 035 991.7

(51) Int. Cl. F16M 13/00; B60R 11/04

(52) U.S. Cl. 248/298.1

(57) ABSTRACT

A device for securing a camera (1) to a carrier has a base part (2) and a securing part (6). The base part (1) is embodied in one piece from sheet metal as a punched and bent part, has guide webs (17, 18, 19) which extend in a longitudinal direction of the base part (2) and is embodied with sprung tongues (31, 32). The securing part (6) has a web receptacle (20) for each guide web (17, 18, 19) so that the securing part (6) can be displaced in a guided fashion, which securing part (6) is embodied with a tongue receptacle (33, 34) for each sprung tongue (31, 32), with which tongue receptacles (33, 34) the sprung tongues (31, 32) engage in a securing position of the securing part (6) and secure the securing part (6) with respect to displacement in the longitudinal direction. As a result, the device which is relatively inexpensive to manufacture can be used to secure and position a camera on a carrier very easily and nevertheless precisely.

### TECHNICAL FIELD

The invention relates to a device for securing a camera to a carrier.

### BACKGROUND OF THE INVENTION

Known from DE 10 2004 032 749 B3 is a device for fastening a rain sensor to a carrier, having a base part and a securing part that can be joined with the base part. The rain sensor is arranged between the base part and the securing part.

### SUMMARY OF THE INVENTION

The invention is based on the problem of providing a device, relatively inexpensive to manufacture, that can be used to secure a camera to a carrier and to position the camera very easily and nevertheless precisely.

This problem is solved with a device for securing a camera to a carrier.

As a result of the fact that the inventive device exhibits a base part that is embodied in one piece from sheet metal as a punched and bent part, and has guide webs that extend in a longitudinal direction, the securing part, which has a web receptacle for each guide web, can be slipped onto the base part very easily. Through the interaction of the spring tongues and tongue receptacles, the securing part and thus a camera joined with the securing part can be positioned precisely in the securing position.

Although the invention has been described with a certain degree of particularity, it should be understood that those skilled in the art can make various changes to it without departing from the spirit or scope of the invention as hereinafter claimed.

### BRIEF DESCRIPTION OF THE DRAWINGS

In the following, a functional embodiment of the invention and advantages of the inventive device are explained in more detail with references to the figures of the drawing. The following are shown:

FIG. 1 A perspective view of an embodiment of an inventive device, looking towards the bottom that faces a carrier,

FIG. 2 A perspective view of an embodiment according to FIG. 1, looking towards the top that faces away from a carrier,

FIG. 3 A perspective view of the base part of the embodiment according to FIG. 1 and FIG. 2, looking towards the side that faces the securing part, and

FIG. 4 A perspective view of the securing part in the embodiment according to FIG. 1 and FIG. 2, looking towards the side that faces away from the base part.

### DETAILED DESCRIPTION

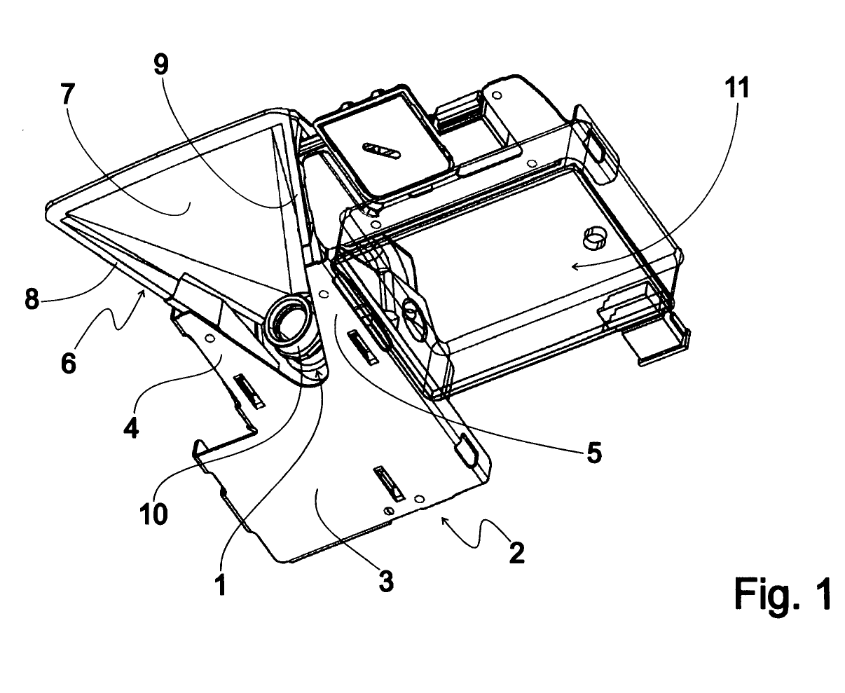

FIG. 1 shows a perspective view of an embodiment of an inventive device for securing a camera 1 to a carrier that is not depicted in FIG. 1 and that is embodied in particular in the form of a window of a motor vehicle. The embodiment according to FIG. 1 has a base part 2 that is embodied in one piece from sheet metal as a punched and bent part. The base part 2 has a flat base plate 3 that is embodied at one end with edge tongues 4, 5 that extend in a longitudinal direction of the base part 2. The edge tongues 4, 5 extend from their joining ends in dovetail fashion with a distance between them that increases in the direction of the free ends, so that a V-shaped lens coverage recess is formed.

Furthermore, it can be seen from FIG. 1 that the embodiment of an inventive device depicted in FIG. 1 has a securing part 6 that is manufactured from plastic, is joined with the base part 2, and is set up to secure the camera 1 in a manner that is explained in more detail below. It can be recognized from FIG. 1 that the securing part 6 has a protective cover 7 that covers the lens coverage recess formed between the edge tongues 4, 5, extends beyond the base part 2 in a prolongation of the diverging inner edges of the edge tongues 4, 5, and decreases in its overall height in the direction pointing away from the camera 1. The protective cover 7 has lateral edge walls 8, 9 that also laterally delimit the lens coverage of a lens 10 of the camera 1, which lens is arranged in the region of the ends of the edge tongues 4, 5 that run towards each other.

Finally, FIG. 1 depicts that in this embodiment a sensor arrangement 11 is attached to the base part 2.

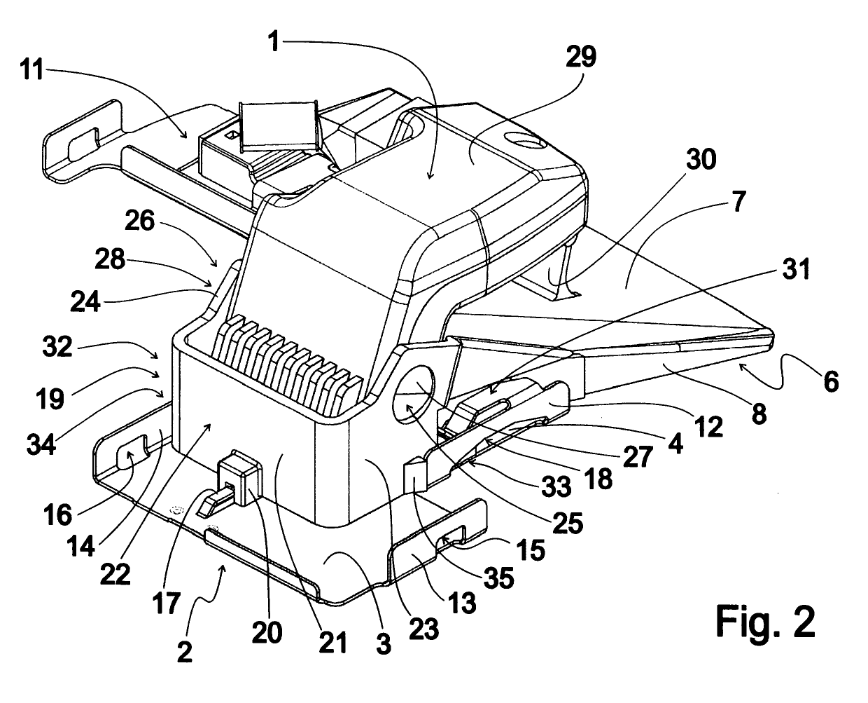

FIG. 2 shows a perspective view of an embodiment according to FIG. 1, looking towards the top that faces away from the carrier, which is not depicted in FIG. 2 as well. It can be seen from FIG. 2 that the base part 2 is embodied with a number of edge webs that extend parallel to the longitudinal direction, namely, on a longitudinal side with an inner edge web 12, with an outer edge web 13 that is offset laterally outward relative to the inner edge web 12 and is embodied with a continuous long edge web 14, all of which extend in the longitudinal direction of the base part 2 and are aligned at a right angle to the base plate 3. Placed in the transition region between the base plate 3 and the outer edge web 13 and the long edge web 14 are engagement recesses 15, 16, in which a system cover not depicted in FIG. 2 can latch and which can serve for gripping during transport of the base part 2.

Punched into the base plate 3 in the form of bridge-like raised areas are a number of guide webs 17, 18, 19 that extend in the longitudinal direction of the base part 2 in order to guide the securing part 6, which is equipped with web receptacles that are embodied complementarily to the guide webs 17, 18, 19, when it is slipped onto the base part 2. As can be seen from FIG. 2, a web receptacle is embodied in the form of a web receptacle socket 20 that extends outward from a face wall 21 of a receiving retainer 22 of the securing part 6.

Furthermore, the receiving retainer 22 has two side walls 23, 24 that are aligned essentially at a right angle to the face wall 21 and extend in the direction of the protective cover 7 on the side of the face wall 21 that faces away from the web receptacle socket 22. Made in each of the side walls 23, 24 is a round latching recess 25, 26, into which latching heads 27, 28, chamfered onto both sides of a central diagonal, of a camera housing 29 of the camera 1 can latch. As a result, the essentially L-shaped camera housing 29 is clasped by one leg of the receiving retainer 22 and mounted on the securing part 6 in pivoting fashion, whereby the other leg is latched with a latching web 30 formed on the protective cover 7.

Finally, it can be seen from FIG. 2 that one spring tongue 31, 32 each is formed on the inner edge web 12 on the top facing away from the base plate 3 as well as on the top of the long edge web 14 facing away for the base plate 3 in order to engage, in the securing position depicted in FIG. 2, with one of the tongue receptacles 33, 34 as soon as a limit stop lug 35 comes into contact with the face side, which faces away from the edge tongues 4, 5, of the inner edge web 12. As a result, both the securing part 6 and, accordingly, the camera 1, are securely and reliably positioned precisely.

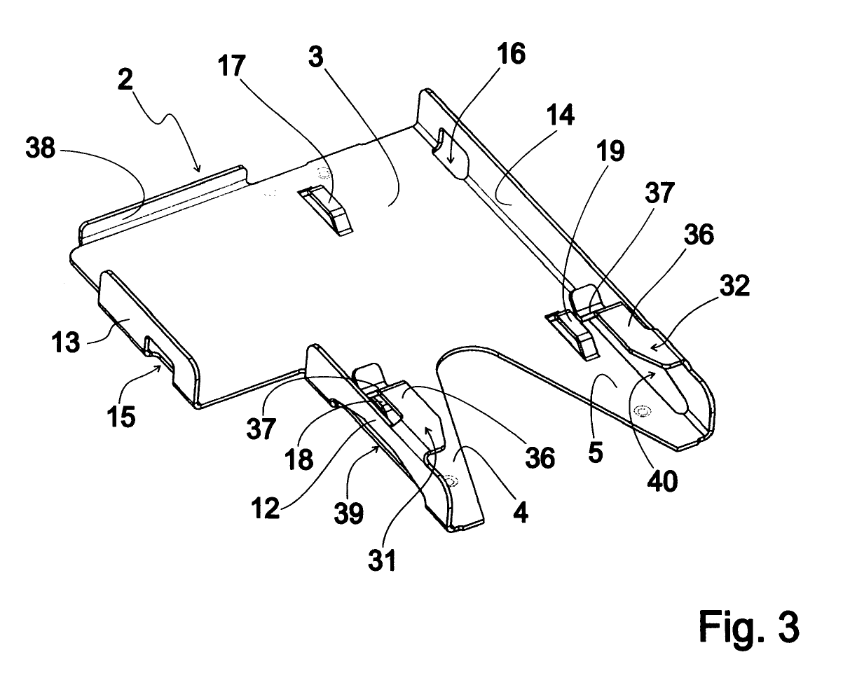

FIG. 3 shows a perspective view of the base part 2 according to the embodiment of FIG. 1 and FIG. 2, looking towards the side that faces the securing part 6. It can be seen from FIG. 3 that the three guide webs 17, 18, 19 in this embodiment extend in the longitudinal direction of the base part 2 and are arranged offset transversely to this longitudinal direction in order to achieve the best possible guiding behavior. Furthermore, it can be seen from FIG. 3 that the spring tongues 31, 32 extend with a tongue segment 36 to the inside of the inner edge web 12 and the long edge web 14 respectively, and due to a cutout, are embodied in springy elastic fashion relative to the inner edge web 12 and the long edge web 14 respectively. Embodied on each of the free ends of the tongue segments 36 that face away from the free ends of the edge tongues 4, 5 is an engagement raised area 37, which is embodied by means of an angled chamfering and which extends in the direction of the base plate 3.

Finally, it should be noted that in order to increase the torsional stiffness of the base plate 3, a face web 38 is embodied at its edge side opposite the edge tongues 4, 5. Longitudinal recesses 39, 40 are embodied in the transition region between the inner edge web 12 and the long edge web 14 and the base plate 3 in order to create a mounting region for the sensor arrangement 11, for example.

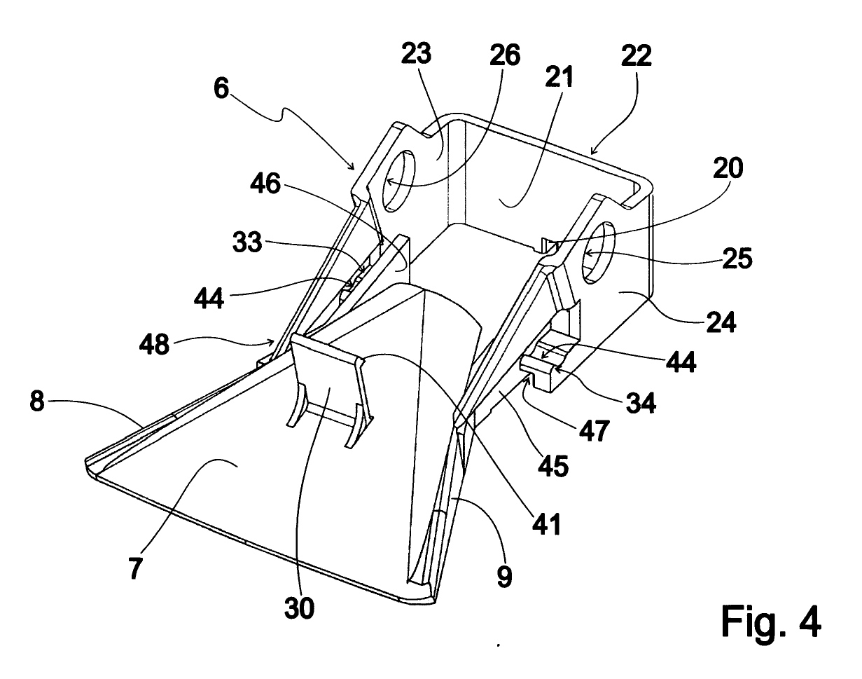

FIG. 4 shows the securing part 6 according to the embodiment explained with the aid of FIG. 1 and FIG. 2, looking towards the side-that faces away from the base part 2. It can be seen from FIG. 4 that for securing the camera housing 29, the latching web 30 is embodied with a web lug 41, which extends in the direction of the receiving retainer 22 and with which the corresponding leg of the camera housing 29 can be latched.

Furthermore, it can be seen from FIG. 4 that placed on the side of the receiving retainer 22 that faces the protective cover 7 are tongue receptacles 33, 34 that are equipped on their side that faces away from the base part 2 with engagement recesses 44 that are embodied complimentarily to the engagement raised areas 37. Web receiving slots 47, 48, which engage with the guide webs 18, 19 that are arranged at the edges, are embodied as additional web receptacles between the tongue receptacles 33, 34 and the protective cover 7 with the joining webs 45, 46 that join the receiving retainer 22.

Although the invention has been described with a certain degree of particularity, it should be understood that those skilled in the art can make various changes to it without departing from the spirit or scope of the invention as hereinafter claimed.

1. Device for securing a camera (1) to a carrier, having a base part (2) and a securing part (6) that can be joined with the base part (2) and is set up to secure the camera (1), whereby the base part (2) is embodied in one piece from sheet metal as a punched and bent part and has a number of guide webs (17, 18, 19) that extend in a longitudinal direction of the part (2), as well as spring tongues (31, 32) that are arranged at a distance transversely to the longitudinal direction, and whereby the securing part (6) has a web receptacle (20, 47, 48) for each guide web (17, 18, 19), so that the securing part (6) can be displaced relative to the base part (2) in a guided fashion, and is embodied for each spring tongue (31, 32) with a tongue receptacle (33, 34) with which the spring tongues (31, 32) engage in a secured position of the securing part (6) relative to the base part (2), and secure the securing part (6) against a displacement in the longitudinal direction relative to the base part (2).

2. Device according to claim 1, wherein the base part (2) has a flat base plate (3) into which the guide webs (17, 18, 19) are punched in the form of raised areas extending in the direction of the securing part (6).

3. Device according to claim 2, wherein the edge webs (12, 13, 14) that stand out from the base plate (3) at a right angle are chamfered.

4. Device according to claim 3, wherein the spring tongues (31, 32)are formed on edge webs (12, 14) that lie opposite each other on the face sides that face away from the base plate (3).

5. Device according to claim 1 wherein each of the spring tongues (31, 32) includes an engagement raised area (37).

6. Device according to claim 5, wherein the securing part (6) includes engagement recesses (44) that are complementarily to the engagement raised areas (37).

7. Device according to claim 1 wherein the securing part (6) has a limit stop lug (35) that in the secured position lies against a face-side edge angle of an edge web (12).

8. Device according to claim 1 wherein the securing part (6) has a receiving retainer (22) with side walls (23, 24) into which the latching recesses (25, 26) are brought for the receiving of latching heads (27, 28) on a camera housing (29) of the camera (1).

9. Device according to claim 3 wherein the receiving retainer (22) includes a limit stop lug (35) that in the secured position lies against an edge web (12, 13, 14).

10. Device according to claim 8, wherein the receiving retainer (22) includes a limit stop lug (35) that in the secured position lies against an edge web (12, 13, 14).

11. A device for securing a camera (1) to a carrier, the device including:
a base part (2) being formed in one piece from sheet metal as a punched and bent part and having a number of guide webs (17, 18, 19) that extend in a longitudinal direction of the part (2), the base part (2) further including spring tongues (31, 32) arranged at a distance transversely to the longitudinal direction; and
a securing part (6) joined with the base part (2) to secure the camera (1), the securing part (6) having:
web receptacles (20, 47, 48) that engage the guide webs (17, 18, 19) of the base part (2) so that the securing part (6) is displaced relative to the base part (2) in a guided fashion, and
tongue receptacles (33, 34) that engage, the spring tongues (31, 32) to secure the securing part (6) against a displacement in the longitudinal direction relative to the base part (2).

12. The device according claim 11, wherein the base part includes a base plate (3) and a plurality of webs (12, 14) that extend away from the base plate (3), each of the plurality of webs (12, 14) including one of the spring tongues (31, 32).

13. The device according to claim 12, wherein one of the webs (12, 14) of the base part (2) includes a face side that engages a limit stop lug (35) on the securing part (6) to limit movement of the securing part (6) relative to the base part (2) in the longitudinal direction.

14. The device according to claim 12, wherein the spring tongues (31, 32), when engaged with the tongue receptacles (33, 34), apply a biasing force to the securing part (6) to secure the securing part (6) against the base plate (3) of the base part (2).

15. The device according to claim 11, wherein the guide webs (17, 18, 19) and the spring tongues (31, 32) extend parallel to one another.

16. The device according to claim 11, wherein the guide webs (17, 18, 19) engage the web receptacles (20, 47, 48) to guide movement of the tongue receptacles (33, 34) toward the tongue members (31, 32) as the securing part (6) is moved relative to the base part (2) along the longitudinal direction.

17. The device according to claim 11, wherein the guide webs (17, 18, 19) comprise raised areas of the base part (2).
